(19) United States
(12) Patent Application Publication
(10) Pub. No.: US 2010/0300000 A1
(43) Pub. Date: Dec. 2, 2010

(54) Single action vent stop

(76) Inventors: Luke Liang, South Plainfield, NJ (US); David Chen, Guangzhou (CN)

Correspondence Address: Thomas A. O'Rourke;Bonder & O'Rourke, LLP, Suite 108, 425 Broadhollow Road, Melville, NY, 11747, US

(21) Appl. No.: 12/456,347

(22) Filed: Jun. 15, 2009

Related U.S. Application Data
(60) Provisional application No. 61/217,365, filed on May 29, 2009.

(51) Int. Cl. E05C 1/12; E05B 55/00

(52) U.S. Cl. 49/449; 292/164

(57) ABSTRACT

A window vent stop for use in a sash window assembly or a door assembly. The vent stop has a housing to be disposed in a recess in the non-movable sash member. This housing includes a cavity with a bottom plate. The tumbler has at least one pivot for pivotally securing the tumbler to the housing for movement between a fully extended position, a halfway extended position. Also within the housing is a spring for biasing the tumbler. The spring maintains the tumbler in a fully retracted position when the sash is in contact with the tumbler, but automatically resets the tumbler to a full extended position when the sash is removed from the tumbler.

This application claims priority on U.S. Provisional Patent Application Ser. No. 61/217,365 filed May 29, 2009.

### FIELD OF THE INVENTION

The present invention relates to single action window vent stops particularly for double hung windows and the like. These window vent stops are used to prevent a window or door from opening more than a desired amount.

### BACKGROUND OF THE INVENTION

There are a number of different types of window vent stops available on the market. These window vent stops are used to restrict the opening of windows and doors. For example, a window may be opened only a portion due to security concerns or to increase comfort in the room. Window vent stops are primarily used on double hung windows and sliding doors where a sash or a door member slides from a first position to a second position. The window sash lock prevents the sash or the sliding door from moving past a selected point. These sash locks can permit the window to be opened a desired amount for ventilation or other purposes.

There are many different types of windows currently available. These windows include casement windows, transom windows, single hung windows, double hung windows, sliding windows, etc. Double hung windows are windows that have a pair of window sashes that may be raised and lowered. Each sash resides in a pair of tracks or recesses that are typically at each side edge of the window. This permits the lower sash to be raised and the upper sash to be lowered. Traditionally, most windows were made of wood. More recently, the windows including the window sashes have been made of extruded metal or plastic.

Single hung windows are similar in design to double hung windows except that there is only one sash that may be raised or lowered. Sliding windows are also not unlike double hung windows in design. While a double hung window has sashes that are raised and lowered, a sliding window has one or more sashes that are movable along a track to the right or left. Similarly, sliding doors operate the same way as sliding windows.

Double hung windows, single hung windows, sliding windows and sliding doors have a variety of open positions in which they may be placed. While a fully opened position can be desirable for ventilation purposes there can be a downside to the fully opened position. One downside is security. A fully open window or door, however, can be a location for unauthorized ingress and egress from the premises. For example, a double hung window that is opened wide can be a source of danger to small children who may climb up to the window. As a result, many municipalities have enacted laws requiring window guards. Additionally, an opened window or door can provide an invitation to third parties to gain access to the building. As a result, there are a number of vent stops that are available to secure a window or door having sliding members in a partially opened position. One such stop is shown in U.S. Pat. No. 5,248,137 owned by Ashland Products. Another sash stop is shown in U.S. Pat. No. 4,923,230 owned by Ro Mai. In each of these sash stops there is a spring biased tumbler or dog that pivots from an unlocked position to a locked position as desired. These sash locks are positioned in the frame of the upper sash and when the tumbler is pivoted outwardly the position of the tumbler prevents the lower sash from being raised above a preselected position. Other prior art patents for similar products are U.S. Pat. Nos. 5,553,236 and 5,806,270 both of which are owned by Ashland.

The typical prior art sash lock operates by a tumbler that is activated by pushing downwardly on the tumbler. The tumbler in the prior art sash locks has a catch portion that contacts the underside of the sash lock housing in a closed position. When the sash lock is intended to be activated, the tumbler is moved in a transverse direction opposite the location of the catch portion to release the catch from the housing. The spring in the sash lock causes the tumbler to be raised into an activated position to lock the sash or door in position.

One of the problems in the operation of the prior art sash locks is that they can be difficult to operate when the user wants to release the window or door for travel. The user must not only push down on the tumbler to release the sash but also must shift the tumbler so that it catches the catch portion of the housing. If the catch portion of the housing is not contacted by the tumbler, the tumbler will be raised due to the pressure of the spring and the sash will not be permitted to move. This creates safety and security concerns, because while the tumbler is in the recessed position, the window is not secure.

While the vent stops of the prior art are generally satisfactory in operation there is also a need for improved vent stops. The problems of the prior art stops is solved by the vent stop of the present invention which operates in a unique manner compared to the traditional sash locks. The vent stop of the present invention is able to lock in the recessed position more easily than the prior art, and automatically releases once the sash is no longer in contact with the top surface of the tumbler. This would save a user time and decrease the risk of accidents occurring from a vent stop with an unsecured window stop.

### OBJECTS OF THE INVENTION

It is an object of the present invention to provide an improved vent stop that is more dependable in its operation than the prior art vent stops.

It is a further object of the present invention to provide a vent stop that provides a mechanism that permits the vent stop to be installed in a variety of different window types and sizes.

It is still another object of the present invention to provide a vent stop that is more flexible in its ability to fit into a variety of recesses carved into a sash stile.

It is still another object of the present invention to provide a vent stop that is more flexible in its ability to fit into a variety of recesses routed into a sash stile.

It is a still further object of the present invention to provide a vent stop that has flexible side engagement pieces which permit the vent stop to be installed in a variety of window types.

It is still another object of the present invention to provide a vent stop that may be released from a retracted position more readily than the prior art vent stops.

It is still another object of the present invention to provide a vent stop that allows the tumbler to be locked in a half extended position with a single press from the user.

It is still another object of the present invention to provide a vent stop which automatically unlocks after the sash has passed over it.

### SUMMARY OF THE INVENTION

The present invention is directed to a single action stop or sash lock for use in a sliding sash window assembly or a sliding door assembly. The window may have one or more sashes, usually upper and lower sash window frames installed for vertical sliding movement. Alternatively, the window may have left and right horizontal sliding sashes. The door may also have one or more sliding doors. One sash frame or sliding door frame has a recess into the interior thereof. The vent stop has a housing adapted to be disposed in the recess.

This housing includes a cavity with a bottom plate therein. Inside the cavity is a tumbler that may be in a retracted position, half extension, and a fully extended position. When the tumbler is in a half extended position, a portion of the tumbler's protruding apex is exposed. In a fully extended position the tumbler has a protruding apex at the top which is full exposed. The apex prevents a sash or door from moving when the apex contacts the sash or the door. The tumbler has one pivot means for pivotally securing the tumbler to the housing for movement between the fully extended position, half extended position, and the retracted position. In the fully extended position, the bottom of the tumbler overlies a portion of the second sash to prevent movement of the lower sash past the tumbler. With a single press, the tumbler will move from the fully extended position, to the half extended position, to the retracted position. When in a half extended position within the cavity the sash or door can be raised and/or moved past the tumbler without interference because the unique design of the tumbler.

Also within the housing is a spring means for biasing the tumbler into the fully extended position. The spring means also resets the tumbler back to the fully extended position when the sash is no longer in contact with the tumbler. The tumbler has at least one means for retaining the tumbler within the housing. The retaining means may be one or more pins that extend laterally from the side of the tumbler and ride within an opening in the side wall of the housing.

Alternatively the retaining means may be one or more recessed areas in the side of the tumbler that received pins on the interior side wall of the housing.

The housing also has at least one side engagement piece, preferably two, which is preferably made from the same type of material as the housing and is flexible and bendable with the sash stile into which the window vent stop is placed. These side engagement pieces are intended to aid in the installation of the window vent stop into the sash stile and are flexible so as to enable the installation of the window vent stop in a wide variety of sash stiles of different sizes.

### BRIEF DESCRIPTION OF THE DRAWINGS

FIG. 1 is an exploded view of a preferred embodiment of the vent stop of the present invention with the tumbler, spring means, and housing.

FIG. 2a is a side view perspective of a preferred embodiment of the vent stop of the present invention with the tumbler in the fully extended position.

FIG. 2b is a top view of a preferred embodiment of the vent stop of the present invention with the tumbler in the fully extended position.

FIG. 2c is a front side end view of a preferred embodiment of the vent stop of the present invention with the tumbler in the fully extended position. Which is a view of the housing and the tumbler.

FIG. 2d is a front view of a preferred embodiment of the vent stop of the present invention with the tumbler in the fully extended position.

FIG. 3 is a side view of a preferred embodiment of the vent stop of the present invention with the tumbler in the half extended position.

FIG. 4a is a side view of a preferred embodiment of the vent stop of the present invention with the tumbler in the fully extended position and an arrow indicating the location and direction a user should apply force to move the tumbler from a fully extended position to a half-extended position.

FIG. 4b is a side view of a preferred embodiment of the vent stop of the present invention with the tumbler in a fully retracted position and an arrow indicating the location of the tumbler.

FIG. 4c is a side view of a preferred embodiment of the vent stop of the present invention with the tumbler in half extended position and an arrow indicating the direction the tumbler is moving.

FIG. 4d is a side view of a preferred embodiment of the vent stop of the present invention with the tumbler in a fully retracted position and an arrow indicating the location of the tumbler.

FIG. 4e is a side view of a preferred embodiment of the vent stop of the present invention with the tumbler in a fully extended position and an arrow indicating the direction the tumbler moves as it returns to a fully extended position FIG. 5 is perspective view of the spring.

FIG. 6 is an exposed perspective view of the inside track portion of the bottom plate of the housing.

FIG. 7a is an exposed perspective view of the inside track portion of the bottom plate of the housing, the u-shaped end of the spring, and the path the u-shaped end portion of the spring takes around the inside track portion indicated with a broken line and a series of arrows.

FIG. 7b is an exposed perspective view of the inside track portion of the bottom plate of the housing, the u-shaped end of the spring in two positions which would manipulate the tumbler to a fully retracted position, and the path the u-shaped end portion of the spring takes around the inside track portion indicated with a broken line and a series of arrows.

FIG. 7c is an exposed perspective view of the inside track portion of the bottom plate of the housing, the u-shaped end of the spring in the position which would manipulate the tumbler to a half extended position, and the path the u-shaped end portion of the spring takes around the inside track portion indicated with a broken line and a series of arrows.

FIG. 7d is an exposed perspective view of the inside track portion of the bottom plate of the housing, the u-shaped end of the spring in the position which would manipulate the tumbler to a fully extended position, and the path the u-shaped end portion of the spring takes around the inside track portion indicated with a broken line and a series of arrows.

FIG. 8 is an exposed perspective view of the inside track portion of the bottom plate of the housing.

FIG. 9 is an exposed perspective view of the vent stop, indicating the tumbler in a fully extended position.

FIG. 10 is a demonstration of a method of operation of the vent stop with a single sash.

FIG. 11 is an exposed perspective view of the inside track portion of the bottom plate of the housing.

FIG. 12 is an exposed perspective view of the inside track portion of the bottom plate of the housing.

FIG. 13 is an exposed perspective view of the inside track portion of the bottom plate of the housing, and the path the u-shaped end portion of the spring takes around the inside track portion indicated with a broken line and a series of arrows.

### DETAILED DESCRIPTION OF THE PRESENT INVENTION

The window or door assembly that may employ the vent stop of the present invention may be a conventional double hung window, a single hung window, sliding window, sliding door and the like. For convenience the present invention will be described with reference to a double hung window but the same applies to each of the above other types of windows and doors having at least one sliding member. The double hung window usually includes upper and lower sash window frames, that are provided with suitable glazing to protect and bed the glass. The sashes are conventionally mounted within a main jamb frame for vertical reciprocal sliding movement therein. Sliding windows and doors are mounted for horizontal reciprocal sliding. Both the jamb frame and the sashes can be formed of different materials, such as metal or rigid plastics well known in this field. When made of metal, the sashes are preferably fabricated from elongated framing members of hollow configuration and are generally rectangular in cross-section and rectilinear in configuration, but the shapes and configurations can vary. The upper sash includes a stile, and the lower sash includes a header having an upper exterior surface. The vent stop of the present invention is designated generally by reference numeral 10. This vent stop may be installed in the exterior front surface of a sash stile, engaging the upper exterior surface of the header of the lower sash, in its locking or extended position. It will be appreciated that the vertical location of the vent stop in the stile will depend upon the amount of vertical movement of the lower sash that is desired before the upper header surface engages the vent stop.

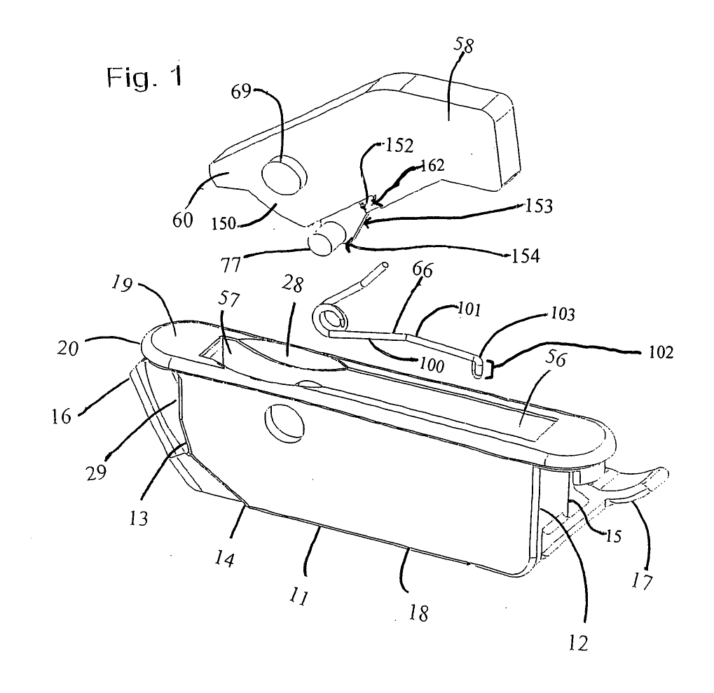

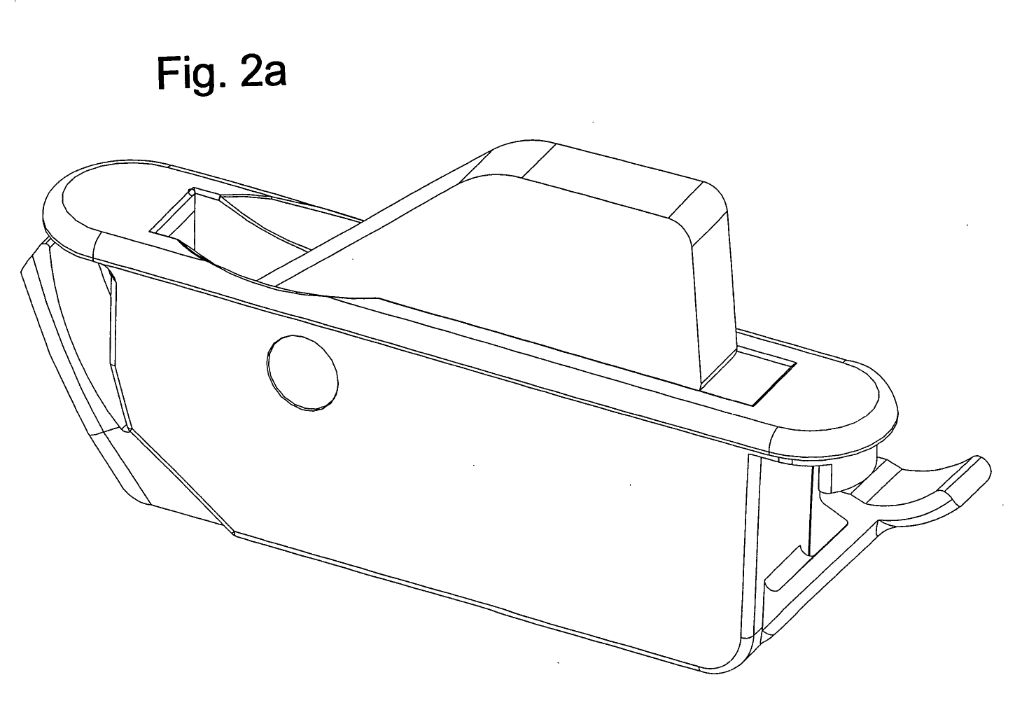

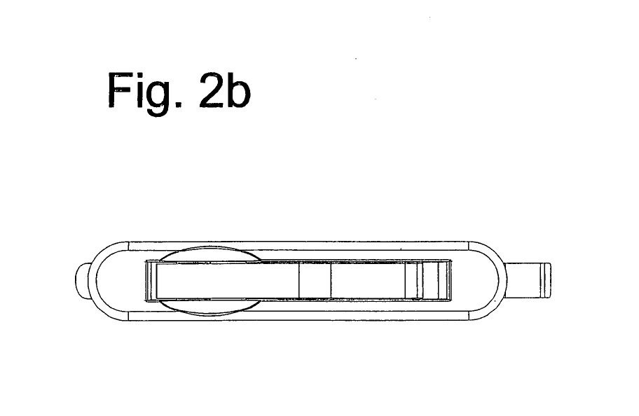

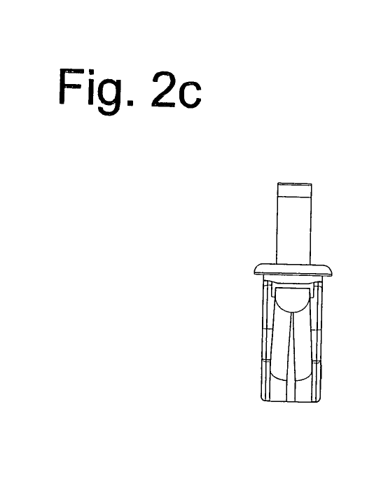

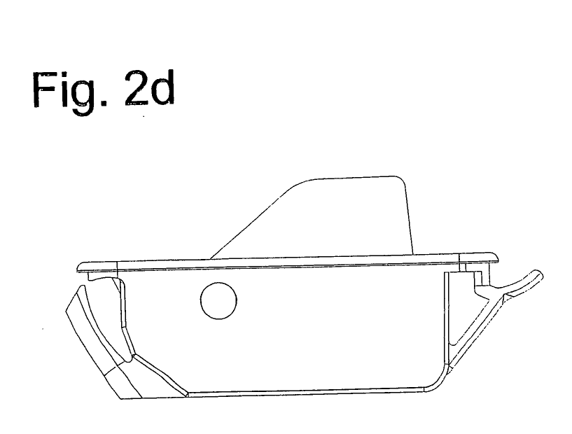

In FIG. 1 the window vent stop of the present invention is shown generally. The vent stop 10 includes a housing 11 that retains the mechanism of the stop. The housing 11 is installed in an opening or recess in the front surface of the sash stile. The housing 11 may have a front wall 12, rear wall 13, and side walls 14 and 15, and a bottom plate 18. If desired there may be a first and/or second flexible clip 16 and 17.

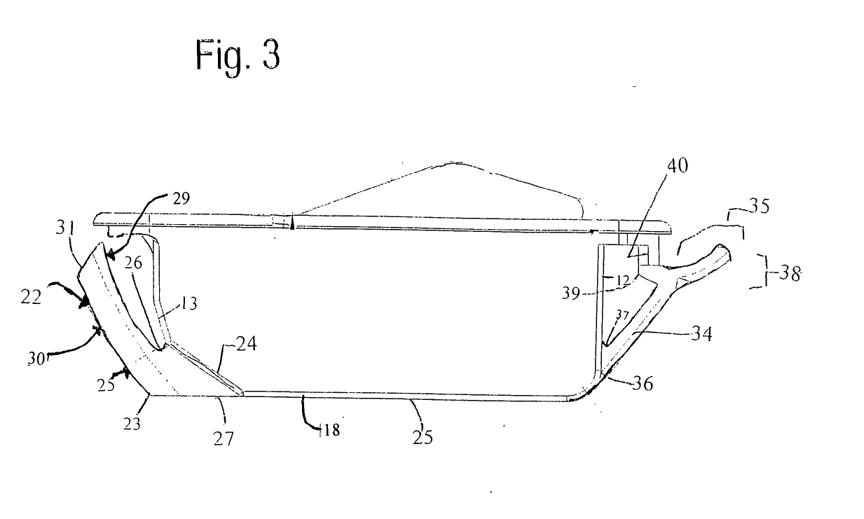

On the top surface of the housing is a faceplate 19 which has a lip portion 20 that overlaps the peripheral edge of the recess to support the housing 11 therein and to furnish an attractive exterior appearance and protect any rough edges in the opening in the sash stile. The first and second flexible clips 16 and 17 may be solid or hollow. FIG. 3 indicates one embodiment in which the first clip is characterized by a protruding arm 22 and a base portion 23 connected to a recessed wall 24 situated between the rear wall 13 and the bottom plate 18 of the housing 11. The base portion has top and bottom surfaces 26 and 27 respectively, as well as a rear surface 25, which may all be generally flat. Extending from the base portion 23 of the first clip 16 is a single protruding arm 22, which is flexible and is at an angle with the rear wall 13. The arm 22 maybe generally rectangular, with an inner surface 29, an outer surface 30, an upper surface 31 and a flat side surface 32, as shown in FIG. 3. The upper surface 31, may be generally pointed. When the vent stop is inserted into a slot in the window sash, the first clip will bend inwardly toward the rear wall 13, until the vent stop fits inside the slot. Once the vent stop 10 has been inserted, the protruding arm 22 will release back to its old position further away from the rear wall 13, with the window sash being secured between the pointed upper surface 31 of the first clip 16 and the lip 20 of the faceplate 19.

In alternate embodiments, the shape of the first clip may be changed. For instance, the upper surface 31 does not have to be pointed, and the arm 22 can attach to the housing 11 at a different point along the rear wall 13. Additionally, a raised member, or tab could extend outwardly from the rear wall 13 so as to limit the amount of room the arm 22 has to move inward toward the rear wall 13. There are other means of providing flexible support similar to the first clip that maybe used.

The second clip 17 comprises an arm 34 and a gripping mechanism 35. See FIG. 3. The arm 34 generally has a base portion 36 that extends outwardly from the front wall 12, so that the arm 34 is generally at an angle to the surface of the front wall 12. As shown in the figures, the arm 34 may be diagonal to the front wall. In the present embodiment, there is a base portion 36 that is generally characterized by a flat upper surface 37. The arm 34 is generally flat, although, in alternate embodiments, it may be curved as so desired. Extending from the top of the side opposite the base portion 36 of the arm 34 is the gripping mechanism 35 of the second clip.

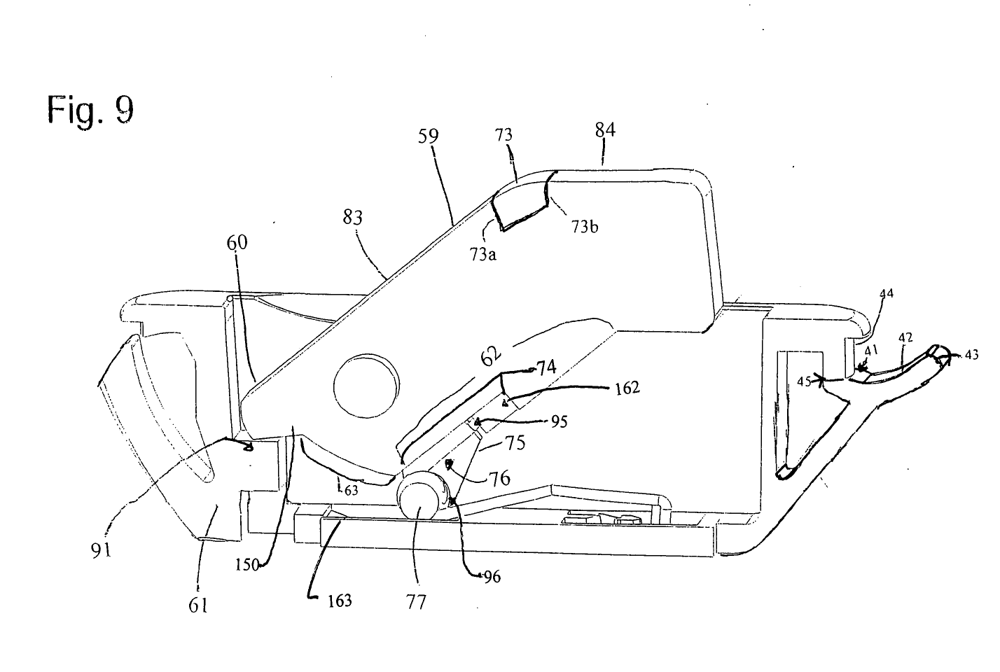

The gripping mechanism 35 comprises a protruding hook 38, a flat support surface 39 and a vertical retaining block 40. The protruding hook 38 extends outwardly from the top of the arm 34 of the second clip 17, and it catches the window sash and secures it to the vent stop 10. It is generally curved upward and has top and bottom surfaces 41 and 42 as well as a front surface 43, as shown in FIG. 9. Although the hook 38 is generally curved, it could be flat in another embodiment, as the user desires. It may be curved in the opposite direction in another embodiment. The hook 38 is connected directly to a flat support surface 39, as shown in FIG. 9 and the purpose of which is to further secure the window sash to the vent stop 10. The support surface 39 comes into contact with a vertical retaining block 40, which has a front end 44 and a back end 45. This retaining block 40 extends upwardly to the lip 20 of the faceplate 19 on the back end 45, and upwardly toward the underside of an inner flange running parallel to the faceplate 19. The retaining block 40 further locks the window sash in place in the clip 20. In various alternate embodiments, each of the various pieces 38, 39, and 40 of the gripping mechanism 35 may be removed. For instance, one embodiment might utilize the hook 38 and the support surface 39, but not the retaining block 40. Any arrangement that would safely secure the window sash 12 within the grip of the clip 20 that is practicable to one knowledgeable in the art is possible.

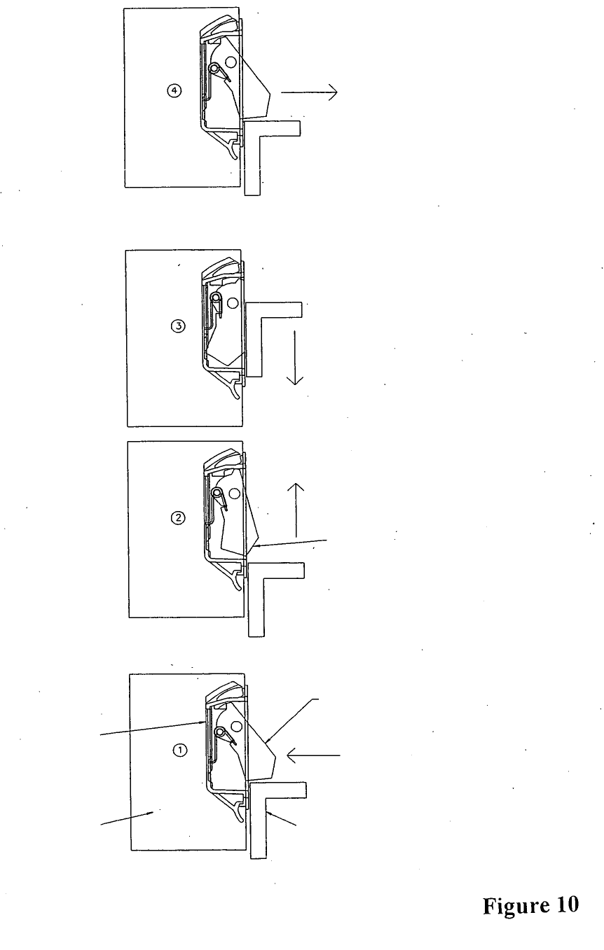

The faceplate 19 includes a centrally located generally elongate vertical opening 56 which is in communication with an interior cavity 57 of the housing 11, as shown in FIG. 1. In a preferred embodiment, there may be two supplementary generally arcuate orifices 28 which are in communication with the vertical opening and allow for greater access to the interior cavity 57. An oblong tumbler 58 is mounted within the cavity 57 to pivot therein and to engage the upper exterior surface of the lower sash header as the lower sash header is raised, as shown in FIG. 10. The tumbler has a top surface 59, and a front surface 150, as shown in FIG. 9. It should be generally understood that the term “front” when used herein to describe the tumbler refers to the portion of the tumbler which is closest to the tab 91 as shown in FIG. 9. The top surface 59 of the tumbler preferably has a protrusion 60 extending from one end thereof that contacts the tab 91 on the inside surface of the front wall of the housing 61 and thus limits the distance the tumbler extends in a fully released position. The top surface of the tumbler 59 will also have a front edge 83, and a rear edge 84. It should be generally understood that the term “rear” when used herein to describe the tumbler refers to the portion of the tumbler which is the furthest away from the 91 as shown in FIG. 9.

The front edge 83 and the rear edge 84 of the top are generally flat and are at angle between 2-70 degrees from each other. The front edge 83 and rear edge 84 may meet at a rounded edge portion 73. It will be appreciated that the orientation of the front edge 83 and rear edge 84 will aid the sash in moving over the top surface of the tumbler 59. In addition a smooth surface on the front edge 83 and the rear edge 84 will also facilitate the movement of the sash over the tumbler's top surface.

The rounded edge portion 73 or the rear edge 84 of the top surface of the tumbler may have an indicator means. The indicator means can be a colored strip of paint or small plastic attachment, or any other means practical in the art to draw the user's attention to the proper location to manually depress the tumbler. In the preferred embodiment the indicator is a small orange plastic insert retained in the surface. The insert may have a top surface flush with the rounded edge portion and two side surfaces 73(a) and 73(b) extended inwardly therefrom. These side surfaces may be angled outwardly to retain the insert in the tumbler.

The tumbler 58 has a bottom surface 62 a front face 63. The front face extends from the end of the front protrusion 60 of the top surface of the tumbler to the bottom surface 62, as shown in FIG. 9. The front face is slightly curved to permit the tumbler to easily move from a retracted position to a half extended position, and subsequently to a fully extended position.

The bottom surface of the tumbler has a middle section 74, as shown in FIG. 9. The middle section 74 has a protruding member 75 which extends from a recessed portion of the middle section of the tumbler 74 and towards the bottom plate of the housing 18. The protruding member has a body portion 76, and a protruding peg 77 which extends from the top surface of the protruding member. The body portion 76 of the protruding member may have any shape to facilitate the function of the protruding peg 77. In one embodiment, the body portion has a straight side 152, an angled side 153 extending from the straight side, a curved side 154, as shown in FIG. 1. The protruding peg 77 will have a radius and a height adapted to receive the spool portion 96 of a spring 66.

Also housed within the cavity is a spring 66, see FIG. 1 and FIG. 5, which provides a means for biasing the tumbler into the fully extended position, as shown in FIG. 9. The spring will have at least one compressed and one relaxed position. In a preferred embodiment, the spring 66 has a pivot arm 95, a spool portion 96, and a free arm 99, as shown in FIG. 5. The pivot arm of the spring is generally cylindrical in shape and has a first end portion 97, and a second end portion 98. In one embodiment, the first end portion 97 extends from the second end portion 98 at a slight angle. It will be appreciated that the slight angle allows the spring to store an increased amount of potential energy, and provide an increased cantilever force to bias the tumbler to a fully extended position.

The center spool 96 extends from the pivot arm 95, and has at least one loop which has a circumference and thickness enabling it to be attached to the protruding peg 77, as indicated in FIG. 9.

The free arm 99 extends from the center spool 96, and has a first section 100, a middle section 101, and a u-shaped end portion 102. The first section 100 extends from the center spool 96 at an angle less than 90 degrees from a plane horizontal with the bottom surface of the tumbler 62 when the spring 66 is in a relaxed position. The middle section 101 of the free arm, extends from the first section 100 of the free arm at angle creating a bend slightly towards a side wall 15 of the housing, as shown in FIG. 1.

The u-shaped end portion 102 will have a curved end 103, a first member 104, a bottom loop 105, and a free end 106. The curved end 103 of the u-shaped end 102 extends from the middle section 101 of the free arm and curves slightly towards the bottom plate of the housing 18, as shown in FIG. 1. The first member 104 of the u-shaped end portion extends from the curved end 103 straight towards the bottom plate of the housing 18. The bottom loop 105 has a generally curved shape, and extends from the first member 104, and up towards the vertical opening 56 of the top plate. The free end 106 extends from the end of the bottom loop opposite the first member 104 towards the vertical opening 56 of the top plate.

Although in a preferred embodiment, the u-shaped end portion 102 is generally in the shape of a “u” with a curved loop 105, it will be generally understood that other shapes are possible, such as a “v” or an “o” or an “l”. Essentially, any embodiment practicable to one in the art that would facilitate the smooth movement of the bottom loop 102 of the spring against the bottom plate.

In a preferred embodiment, when protruding peg 77 has received the spool portion of the spring 66, the pivot arm 95 will be in contact with the recessed portion of the middle section 74 of the tumbler, and the free arm will be in contact with the bottom plate, as shown in FIG. 5.

In one embodiment, the bottom surface of the tumbler 62 further comprises a rectangular bracing member 162, which extends down from the bottom surface of the tumbler and the middle section 74 of the tumbler at a location closer to the front surface of the tumbler 150 than the protruding member 75. Once the spool portion of the spring is engaged with the protruding peg 77, the pivot arm 95 rests behind the bracing member 162, where it provides a biasing force helping to keep the spring in place, as shown in FIG. 9.

In another embodiment, the bottom surface of the tumbler 62 further comprises a cylindrical post, which extends down from the bottom surface of the tumbler and the middle section 74 of the tumbler at a location closer to the front surface of the tumbler 150 than the protruding member 75. Once the spool portion of the spring is engaged with the protruding peg 77, the pivot arm 95 rests behind the cylindrical post where it provides a biasing force helping to keep the spring in place.

The bottom plate of the housing 18 may be a separate member or may be integral with the housing. The bottom plate has a top surface 107 and a bottom surface 108. The top and bottom surface are separated by a body portion 109. In the top surface of the bottom plate is a recessed track portion 78, and a front recessed portion 163, as shown in FIG. 9.

The front recessed portion 163 is generally a rectangular orifice and has a depth adapted to receive a portion of the protruding peg 77. In one embodiment, the front recessed portion 163 begins where the tab 91 on the inside surface of the front wall of the housing 61 extends from the front wall and ends approximately half-way across the bottom plate 108, as shown in FIG. 9.

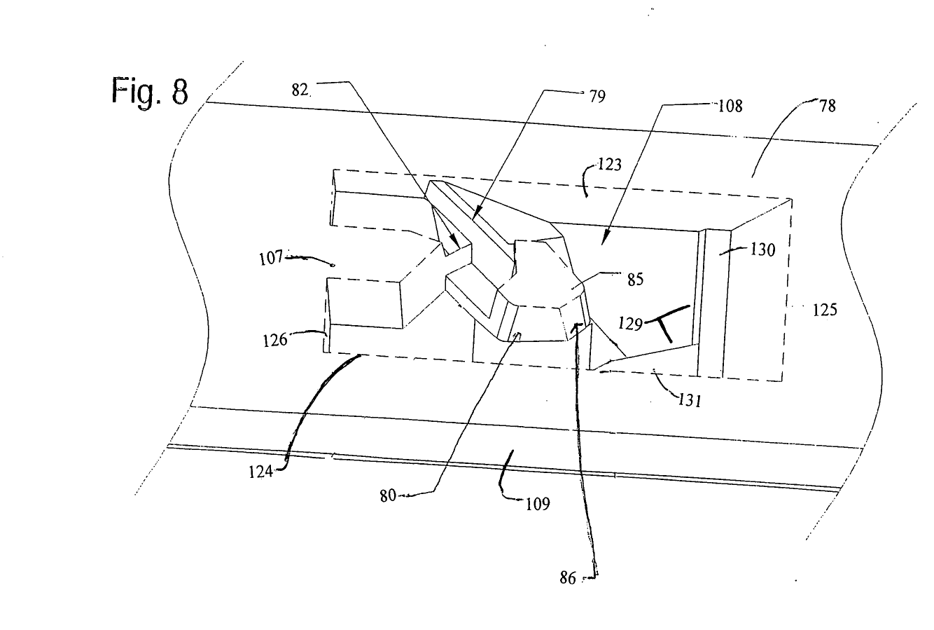

The recessed track portion has a first side wall 123 extending into to the body portion 109, a second side wall 124 opposite the first side wall and a third 126 side wall extending from the first side wall to the second side wall, as shown in FIG. 8. Opposite the third side wall 126 is a fourth side wall 125 that includes a first portion 127 and a second portion 128 generally parallel to the third side wall and preferably in generally the same plane.

Extending from one end of the first side wall portion of the fourth side wall 125 to one end of the second side wall portion of the fourth side wall is a block portion 129. The block portion has a first side wall 130 extending in to the recess from the first side wall position of the fourth side wall 125. The block portion also has a second side wall 131 extending into the recess from second side wall extending into the recess from the second side wall. The block portion also contains a barrier member 147 which is adapted to guide the u-shaped portion along the track.

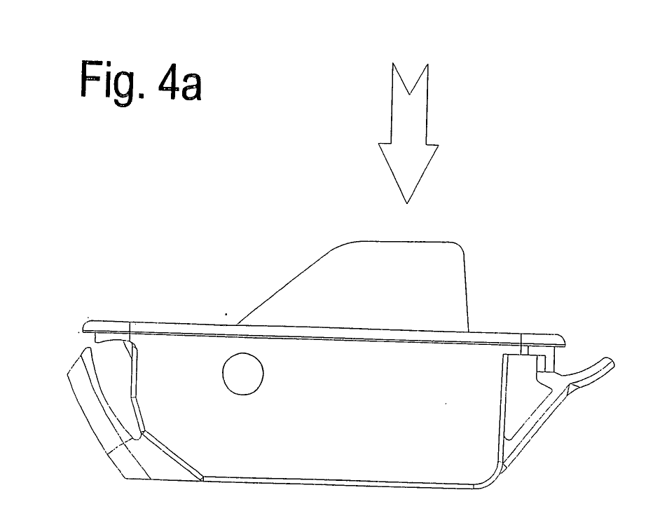

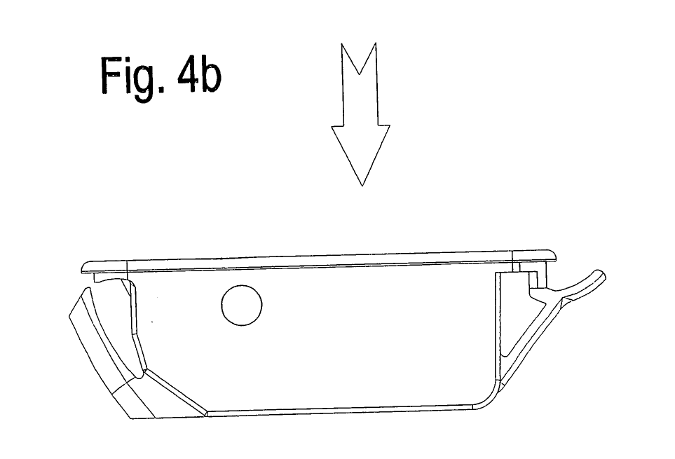

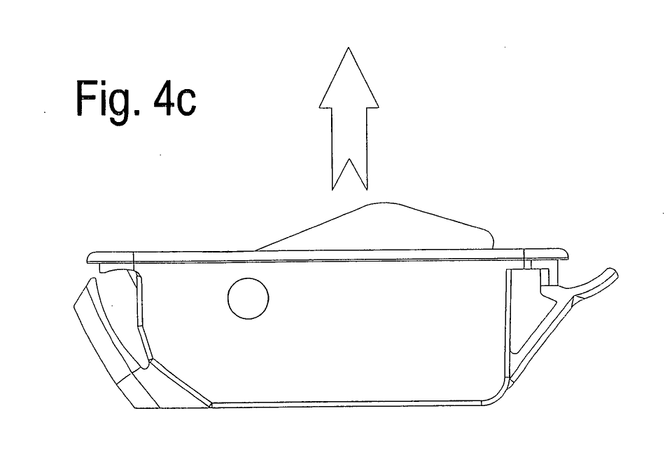

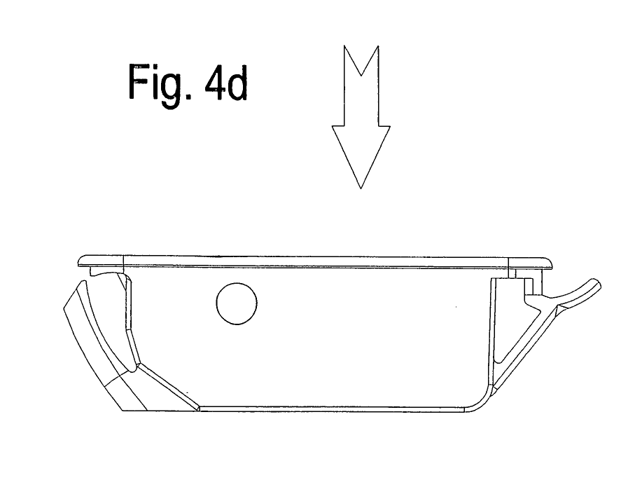

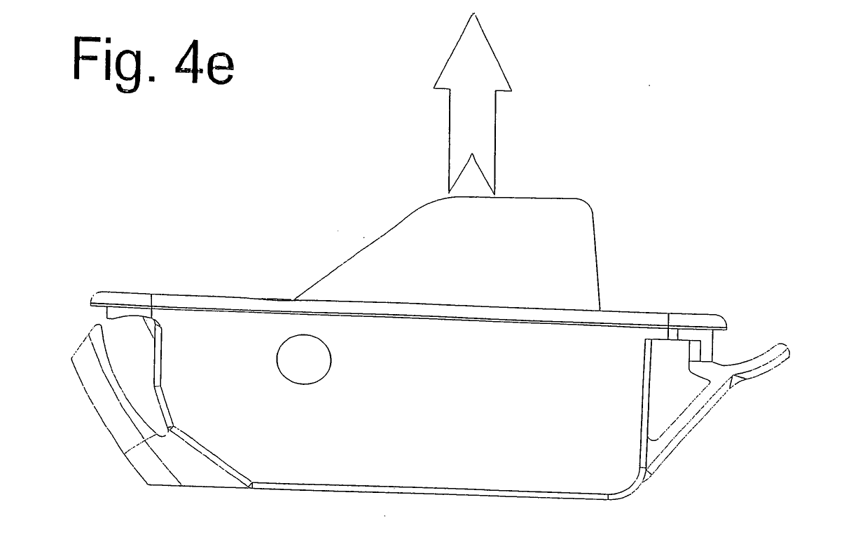

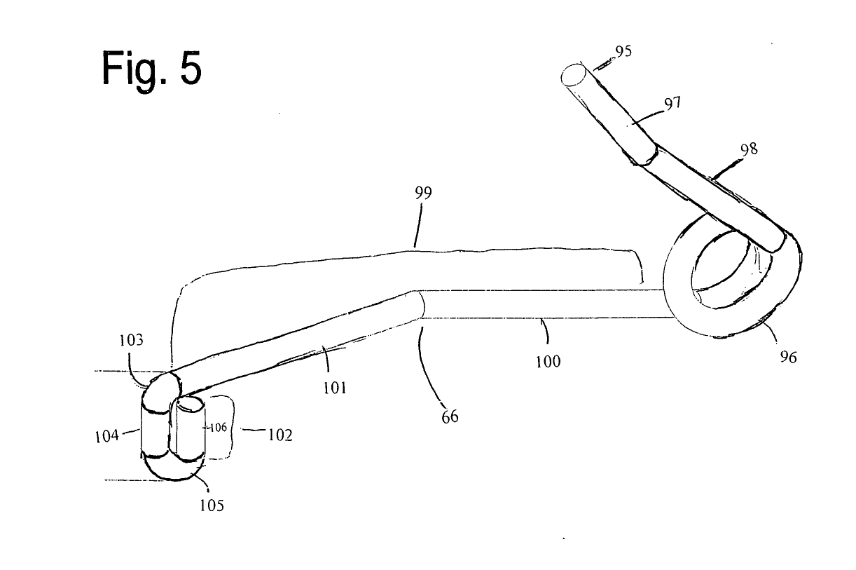

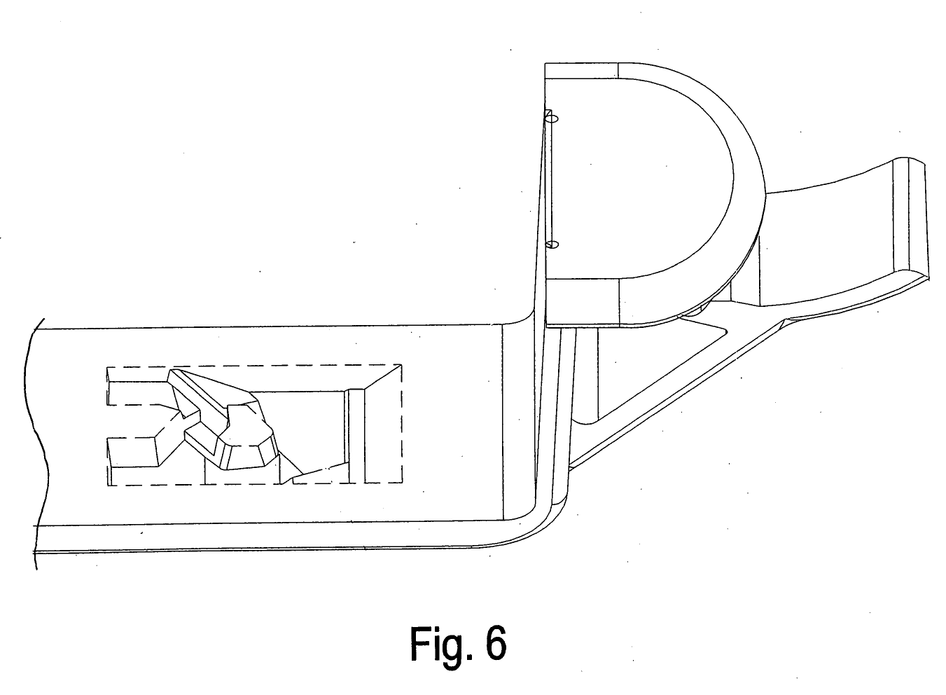

The recessed track portion is further comprised of a plurality of frustum 79, 80, as shown in FIG. 8. In one embodiment, the frustum generally extend upward from the center of the bottom surface of the plate 108. Each frustum will have at least one surface which is generally vertical 82. Each frustum may also have one surface which is generally horizontal 85, and possibly an angled surface 86. It will be generally understood that the amount of surfaces and the orientation of each surface of a frustum can vary, so long as the frustum is able to guide the movable end the spring to have three stationary positions which will manipulate the position of the tumbler to a fully extended position (See FIG. 4a), a half extended position (See FIG. 4c), and a retracted position (See FIG. 4b).

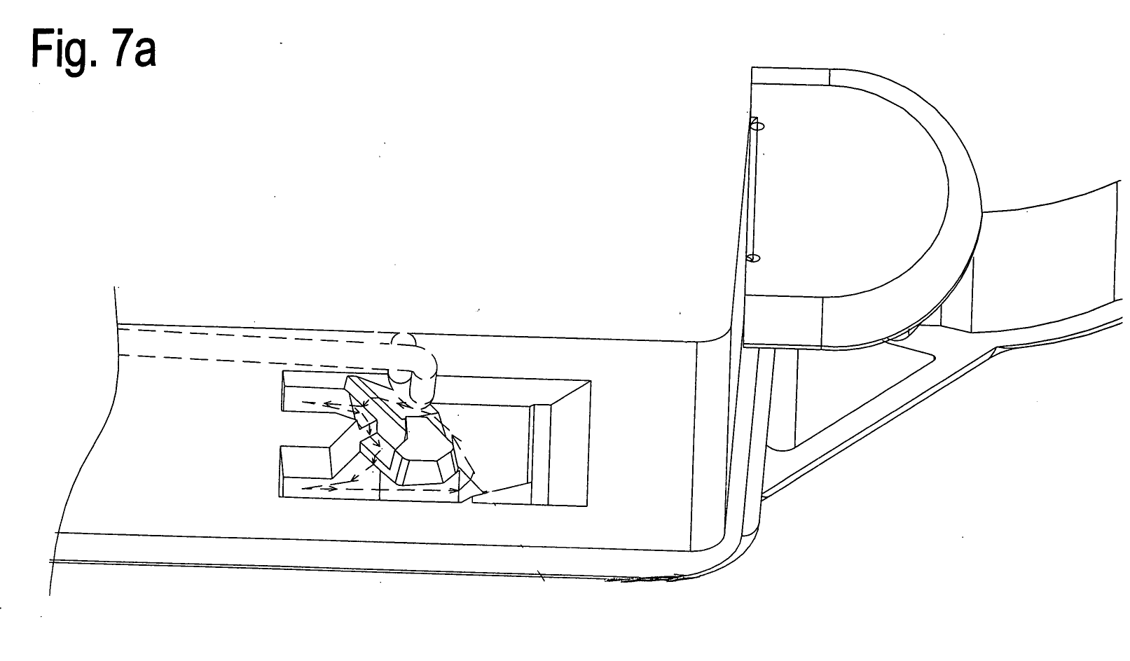

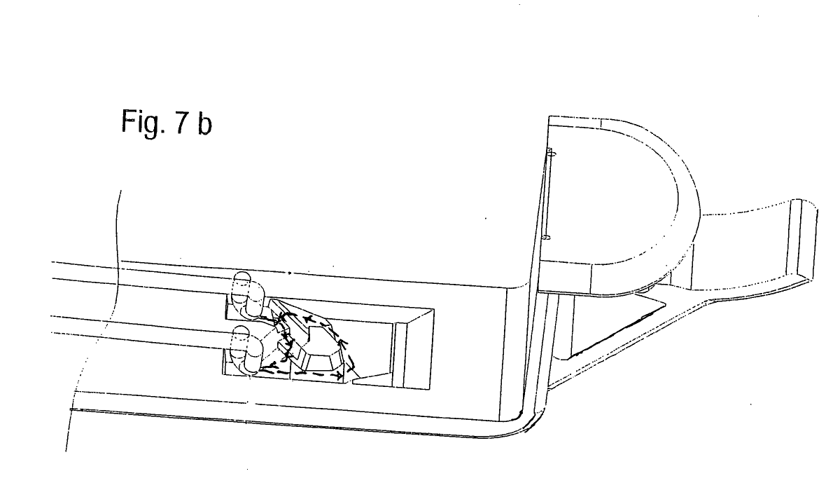

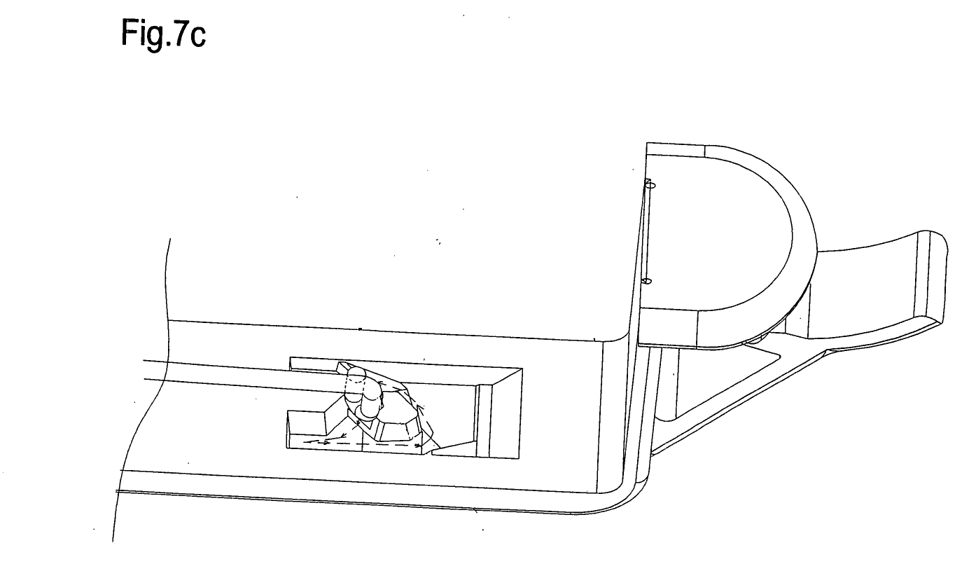

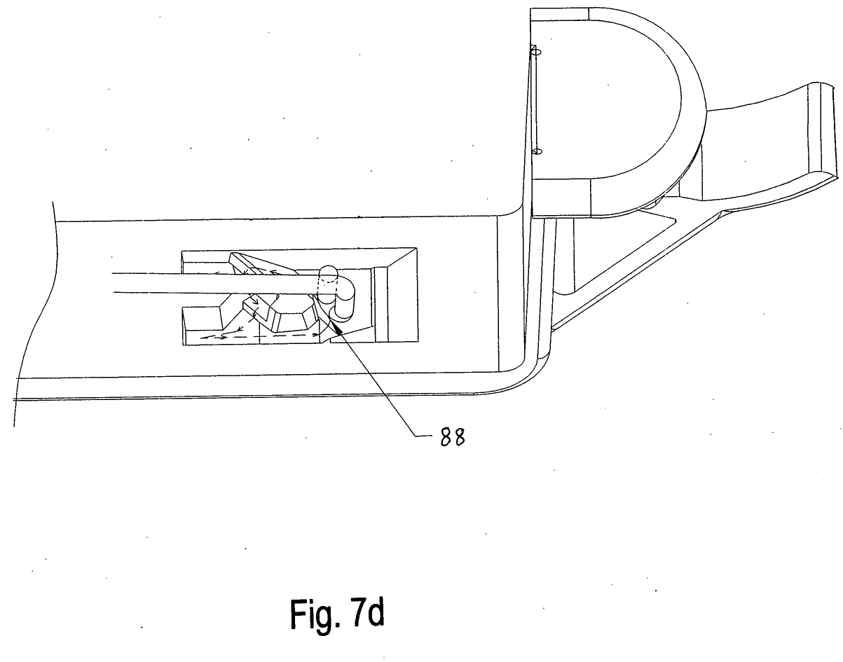

The number and arrangement of frustum will be in a manner that allows the movable end the spring to have three stationary positions which will manipulate the position of the tumbler to a fully extended position (See FIG. 4a), a half extended position (See FIG. 4c), and a retracted position (See FIG. 4b). In one embodiment, the first stationary position 88 of the u-shaped end of the spring 102 is on the bottom surface 108 of the bottom plate, as shown in FIG. 7d. In this embodiment, when u-shaped end of the spring 102 is in this position, the spring maintains the tumbler in a full extended position, as shown in FIG. 4e.

In one embodiment, there may be a first 79 and second frustum members 80, extending upwardly from the bottom inside surface of the bottom plate 108, as shown in FIG. 8. The first frustum member 79 comprises a plurality of sidewall surfaces, e.g. a first surface 110, second surface 111, third surface 112, fourth surface 113, fifth surface 114, sixth surface 116, and a seventh surface 121, as shown in FIG. 1. The first surface 110 of the frustum member 80 is generally: flat, horizontal and flush with the top surface 107 of the bottom plate. The second surface 111 of the frustum member 80 is generally at an obtuse angle with respect to the first surface 110, and slopes downward toward the bottom surface 108 of the bottom plate, while generally facing the third side wall 125 of the recessed track portion.

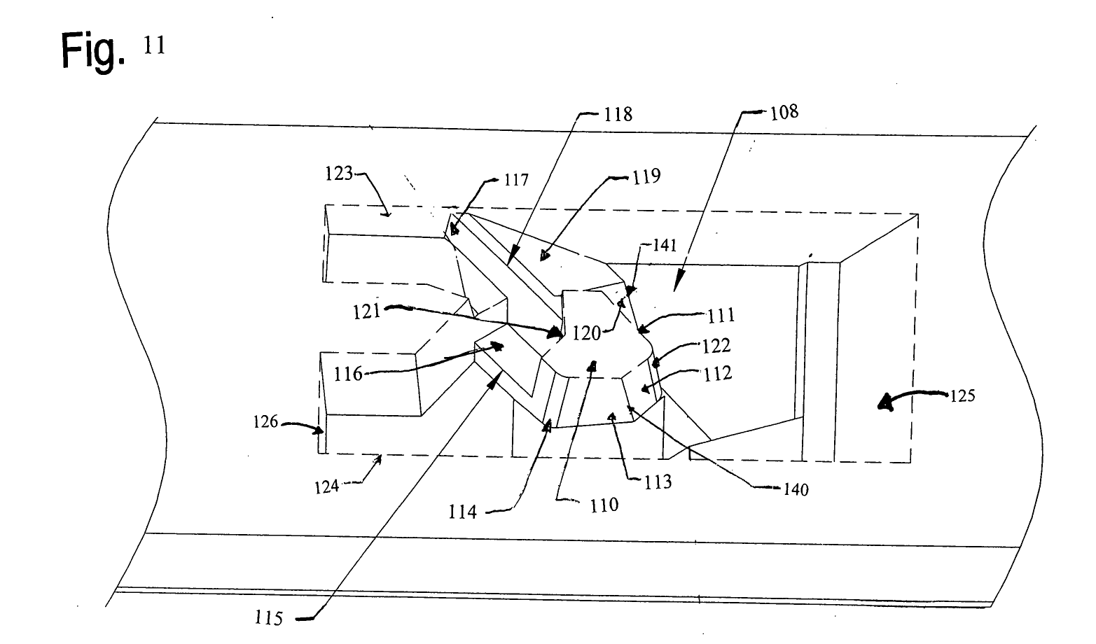

The third surface 112 of the frustum member 80 is generally at an obtuse angle with respect to the first surface 110 sloping downward toward the bottom surface 108 of the bottom plate, and is at an acute angle with respect to the second surface 111, and generally faces the second side wall 124 of the recessed track portion. The third surface 112 meets the second surface 111 at a rounded edge portion 122, as shown in FIG. 11.

The fourth surface 113 of the frustum member 80 is generally at an obtuse angle with respect to the first surface 110 sloping downward toward the bottom surface 108 of the bottom plate, and is at an obtuse angle with respect to the third surface 112, and generally faces the second side wall 124 of the recessed track portion. The fourth surface 113 meets the third surface 112 at a pointed edge 140, as shown in FIG. 11.

The fifth surface 115 of the first frustum member 79 is generally at an obtuse angle with respect to the first surface 110 sloping slightly downward toward the bottom surface 108 of the bottom plate, and is at an obtuse angle with the fourth surface 113, and generally faces the second side wall 124 of the recessed track portion. The fifth surface 115 meets the fourth surface 113 at a rounded edge portion 114, as shown in FIG. 11.

The sixth surface 116 of the frustum member 80 is generally parallel with respect to the first surface 110, and is perpendicular with respect to the fifth surface 115 of the frustum member 80.

The seventh surface 121 of the frustum member 80 is generally perpendicular with respect to the first surface 110, and is perpendicular with respect to the sixth surface 110 of the frustum member 80. The seventh surface generally faces the third side wall 126 of the recessed track portion.

The frustum member 79 comprises a first surface 117, second surface 119, third surface 120, and in some embodiments a fourth surface 141. The first surface 117 of the frustum member 79 is generally at an obtuse angle with respect to the sixth surface 116 of the frustum member 80, and generally faces the fourth side wall 126.

The second surface 119 of the frustum member 79 is slopes downward at an acute angle with respect to the first surface 117, and generally faces the fourth side wall 125 of the recessed track portion. In an alternative embodiment, the second surface 119 might have a curved slope. The second surface 119 meets the first surface 117 at a rounded edge portion 118, as shown in FIG. 11. In one embodiment, the second surface 119 contacts the first side wall 123 of the recessed track portion.

The third surface 120 of the frustum member 79 is at an obtuse angle with respect to the second surface 119, and generally faces the second side wall 124 of the recessed track portion. In one embodiment, the third surface 120 meets the second surface at a rounded edge portion. In an alternative embodiment, the third surface 120 meets the second surface 119 at angle such that the second surface 119 and third surface 120 are in the same plane.

In an embodiment where the third surface 120 meets the second surface 119 at angle such that the second surface 119 and third surface 120 are not in the same plane, the frustum 79 has a fourth surface 141. In this embodiment, the fourth surface 141 of the frustum member 79 is at an obtuse angle with respect to the second surface 119, generally at an obtuse angle to the third surface 120 of the frustum member 79, and generally faces the fourth side wall 125 of the recessed track portion.

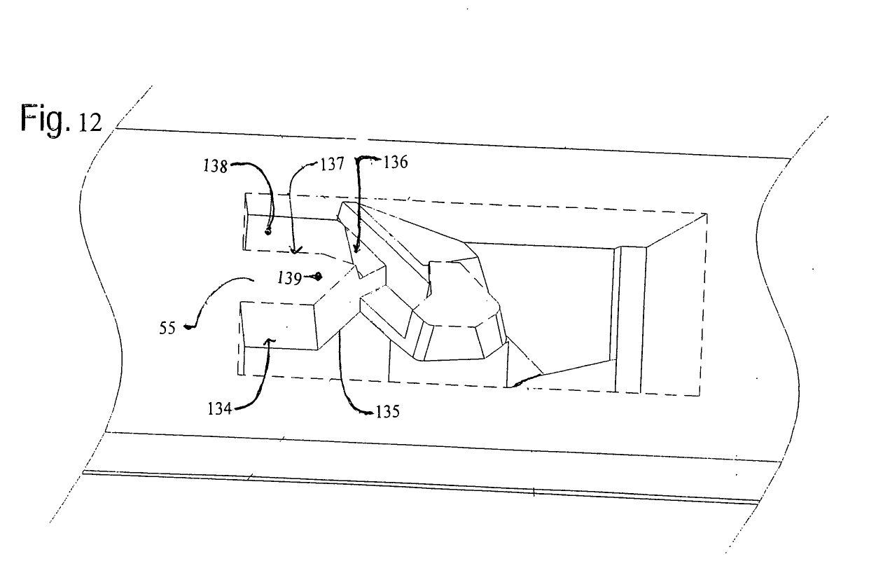

In one embodiment, there could be a barrier member 55 which extends from the third side wall 126, as shown in FIG. 12. In such an embodiment, the barrier member 55 could comprise a plurality of surfaces, e.g. a first surface 134, second surface 135, third surface 136, fourth surface 137, and fifth 138 surface 64, which may come into contact with the movable arm of the spring 99, and be adapted to guide the movable arm along a set path, as shown in FIG. 7b. The barrier member further comprises a top surface 139, which is generally horizontal and parallel to the top surface 107 of the bottom plate.

The first surface 134 of the barrier member is generally perpendicular to the top surface 139 and the third side wall 126, and faces the second side wall 124 of the recessed track portion.

The second surface 135 of the barrier member extends from the first surface 134 at an obtuse angle, and is generally perpendicular to the top surface 139 of the barrier member.

The third surface 136 of the barrier member extends up from the first surface 134 of the barrier member at a positive acute angle, and generally faces the second side wall 124.

The fourth surface 137 of the barrier is perpendicular to the top surface of the barrier member 139, and extends from the third side wall 126 to the second surface 135. The fourth surface also generally faces the first side wall 123.

The fifth surface 138 is generally flat and parallel to the top surface 139 of the barrier member. The fifth surface 138 also extends from the third side wall 126 to the third surface 136.

In one embodiment, when a user desires to open a window secured by the vent stop of the present application, the top surface of the tumbler 59 is manually depressed with a continuous amount of manual force which causes the tumbler 58 to pivot about a pin 69. The pin may extend from one orifice in a side wall 13 to the other 14. The pin may be any shape.

As the tumbler rotates about the pin 69 the bottom surface of the tumbler 62 begins to compress the pivot arm of the spring 95, which forces it to rotate about the protruding peg 77, down towards the bottom surface 108 of the bottom plate. This causes a compressive force to transfer through the spool portion 96 of the spring, and causes the free arm 99 of the spring to rotate down towards the bottom surface of the bottom plate 108 and compress. As the free arm 99 compresses, the bottom loop 105 provides an upward biasing force towards the faceplate 19. As the bottom loop 105 provides an upward biasing force, the middle section of the free arm 101 will rotate down towards the bottom plate 108 and generally toward the first sidewall 123 of the recessed track portion, as a result of the middle section 101 being at angle with respect to the first section 100.

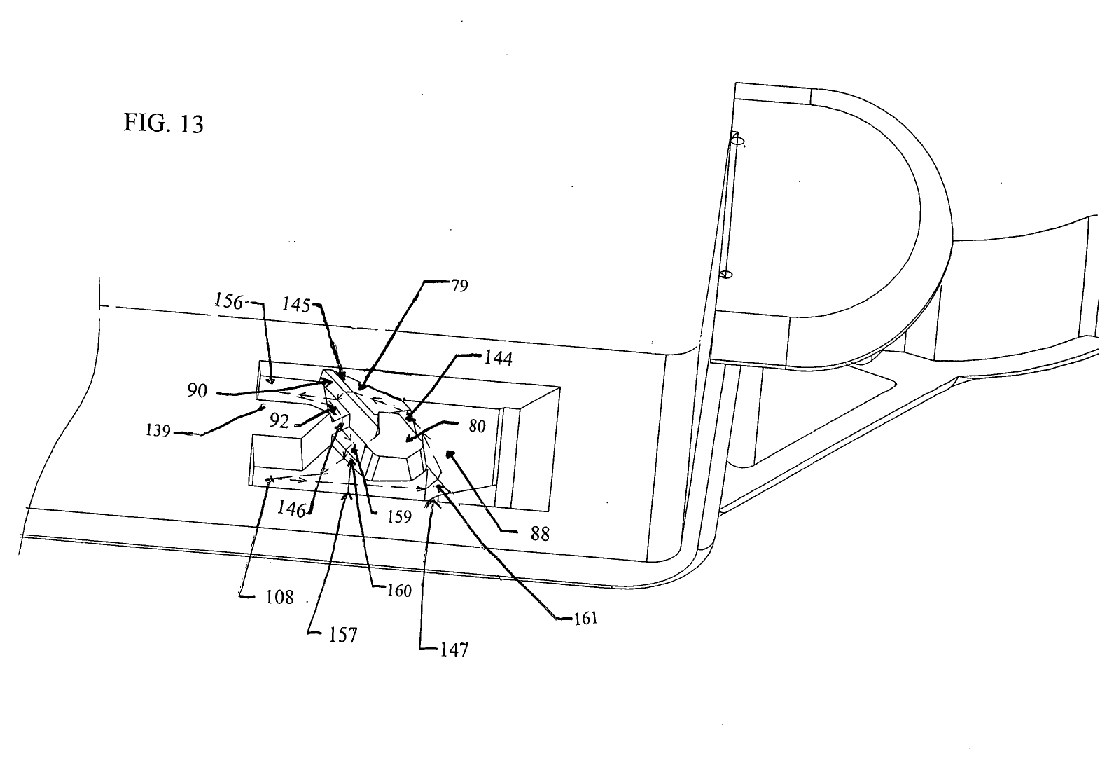

The rotation of the middle section 101 of the spring generally towards the first sidewall of the recess track portion results in the movement of u-shaped end of the spring 102 to move from the first stationary position 88 to an angled surface 144 of a frustum member 79, over that angled surface 144, across a second angled surface 145, and down a vertical surface 90 of the same frustum member 79, as shown in FIG. 13. FIG. 13 also generally indicates the path of the u-shaped end of the spring in a broken line bisected by arrow heads.

The user must continue to apply a manual force to the top surface of the tumbler 59, so that the u-shaped end of the spring 102 will continue to move from this vertical surface 90 and travel across the horizontal surface 156 of the barrier member 139. When the unshaped end of the spring 102 is in this position, the tumbler will be completely housed within the cavity and in a fully retracted position.

The user then discontinues applying force to the top surface of the tumbler 59, which causes the spring to attempt to return to its relaxed position. The pivot arm of the spring 95 will rotate up towards the faceplate 19. As the pivot arm of the spring 95 rotates up towards the faceplate 19, the first section 100 of the free arm will begin to relax and also rotate up toward the faceplate 19. The rotation of the first section 100 of the free arm up towards the faceplate 99 causes the middle section of the free arm 101 to rotate up towards the face plate and generally forward towards the second sidewall 124 of the recessed track portion, as a result of the middle section 101 being at angle with respect to the first section 100. This will cause the u-shaped end to move down an angled surface 92 of the barrier member 139, down another vertical surface 146, and across another horizontal surface 159 of the barrier member 139 at approximately the middle left quadrant of the recesses track portion, as shown in FIG. 13.

As the u-shaped end of the spring travels from the horizontal surface 156 of the barrier member 139, down the angled surface 92 of the barrier member 139, down the vertical surface 146 of the barrier member, and finally across the other horizontal surface 159 of the barrier member, the pivot arm of the spring 95 will rotate up pushing up on the bottom surface 62 of the tumbler, which causes the tumbler to rotate up about the pin. The tumbler will rotate a certain distance so that the apex of the tumbler is exposed a distance from around 0.079 inches to 0.315 inches from the vertical opening 56 of the faceplate. When the apex of the tumbler is exposed a distance from around 0.079 inches to 0.315 inches from the vertical opening 56 of the faceplate, the tumbler is in the half extended position. When the u-shaped end of the spring is on the other horizontal surface 159 of the barrier member, it is in the second stationary position of the moveable end of the spring.

Once the tumbler is in a half extended position, the user then needs to push the window sash in the direction so that it begins to make contact with the rear edge 84 of the tumbler, as shown in FIG. 10. As continuous manual force is applied to the sash, the rear edge 84 of the tumbler will guide the sash over the top surface of the tumbler causing a downward force to be applied to the rear edge of the tumbler, and the tumbler will continue to rotate about the pin 69, as shown in FIG. 10. The bottom surface of the tumbler 62 will begin to rotate, which will compress the pivot arm of the spring 95, which transfers that force through the spool portion 96 of the spring, and causes the free arm 99 of the spring to rotate down towards the bottom surface of the bottom plate 108 and compress. As the free arm 99 compresses, the bottom loop 105 provides an upward biasing force towards the faceplate 19. As the bottom loop 105 provides an upward biasing force, the middle section of the free arm 101 will rotate down towards the bottom plate 108 and generally towards the second sidewall 124 of the recessed track portion, as a result of the middle section 101 being at angle with respect to the first section 100. The rotation of the middle section 101 of the spring towards the first sidewall of the recess track portion results in the movement of u-shaped end of the spring 102

The u-shaped end of the spring 102 will then move from the horizontal surface 93 of the barrier member 159, down the vertical surface of the barrier member 160, and across the horizontal surface of the bottom surface of the bottom plate 108. As the u-shaped end of the spring 102 moves to this position, the tumbler will descend further into the cavity of the housing 57 until it is completely housed in the cavity and in the fully retracted position. The tumbler will remain in this position as long as the sash is in contact with the rear edge 84 of the tumbler, because the sash will continue to provide a biasing force which will keep the spring in this position.

When the user desires to open the window and reset the vent stop, all that needs to be done is to move the sash in a direction so that it is no longer in contact with the rear edge 84 of the tumbler, as shown in FIG. 10. Once the sash is no longer in contact with the rear edge 84 of the tumbler, the sash no longer provides a biasing force, the spring will attempt to return to its relaxed position. The pivot arm of the spring 95 will rotate up towards the faceplate 19. As the pivot arm of the spring 95 rotates up towards the faceplate 19, the first section 100 of the free arm will begin to relax and also rotate up toward the faceplate 19. The rotation of the first section 100 of the free arm up towards the faceplate 99 causes the middle section of the free arm 101 will rotate up towards the face plate and forward generally towards the second sidewall 124 of the recessed track portion, as a result of the middle section 101 being at angle with respect to the first section 100. This will cause the u-shaped end to move across the horizontal surface of the bottom surface of the bottom plate 108, up an angled surface 157 of the bottom plate, up another slightly angled surface 161, and across the horizontal surface of the bottom surface of the bottom plate 108, and may push up against a guide member 147, and back to the first stationary position 88.

As the u-shaped end of the spring 102 moves towards this position, the pivot arm of the spring 95 will rotate up towards the faceplate 19, which will case the bottom surface of the tumbler 62 to rotate up towards the faceplate 19, and result in entire tumbler rotating up towards the faceplate 19 about the pin 69 out of the vertical opening and to a fully extended position.

Having described and illustrated the principles of the vent stop with reference to several illustrative embodiments, it will be recognized that these embodiments are exemplary only and should not be taken as limiting the scope of the invention. Guided by the foregoing teachings, it should be apparent that frustum with various amount of surfaces, at various orientations, and placed in different locations can achieve a vent stop which achieves similar effects to the embodiments detailed above.

I claim:

1. A vent stop for use in a sliding member comprising a housing, a spring and a tumbler, said tumbler being rotatably mounted in said housing and having a fully retracted position wherein a portion of the tumbler does not extend from said housing, a fully extended position wherein a portion of said tumbler extends from said housing and a partially extended position wherein less of said tumbler extends from said housing then when said tumbler is in its fully extended position and wherein said spring causes said tumbler to move from said retracted position.

2. The vent stop according to claim 1 wherein said vent stop can move from the partially extended position to said fully extended position when a force is placed on said portion of said tumbler extending from said housing causing said tumbler to retract further into said housing, said force causing said tumbler to be released from its partially retracted position to extend to its fully extended position.

3. The vent stop according to claim 2 wherein said spring has a first end and a second end portion and wherein said first end portion contacts said tumbler and wherein said second end portion moves from a first position to a second position to a third position in said housing as said tumbler moves from a retracted position to a partially extended position to a fully extended position.

4. The vent stop according to claim 3 wherein said housing has a top surface having an opening from which said tumbler extends, a first sidewall and second sidewall opposite said first sidewall and a first end wall, said end walls and said sidewalls extending from said top surface, said end walls also extending from said first sidewall to said second sidewall and said housing having a base at an end of said sidewalls opposite said top surface, said base having an inner surface and an outer surface, said inner surface of said base having a recess area in said inner surface, said recess area providing a track for said second end portion of said spring to travel as said tumbler is moving from a first position to a second position.

5. The vent stop according to claim 4 wherein said spring has a first end portion secured to said tumbler and a second end portion that travels in said recess portion.

6. The vent stop according to claim 4 wherein said recess has a first sidewall, a second sidewall and a first end wall, and a second end wall, one of said end walls extending from one sidewall to the opposite sidewall, the other of said end walls having a first end wall portion extending from one sidewall and a second end wall portion extending from the opposite sidewall, said first and second end wall portions being separated by a center end wall portion that extends into the recess area formed in said bottom wall.

7. The vent stop according to claim 6 wherein said center end wall portion has at least a first sidewall and a second sidewall, said first sidewall of said center end wall portion extending from an end of said first sidewall portion opposite said first sidewall of said recess and said second sidewall of said center end wall portion extending from an end of said second sidewall portion opposite said second sidewall of said recess.

8. The vent stop according to claim 7 wherein said sidewalls and said end walls of said recess area extend from a top of the inner surface of said base to a floor area in said recess area.

9. The vent stop according to claim 8 wherein said center end wall portion extends from a top of the inner surface of said base to a floor area in said recess area.

10. The vent stop according to claim 8 wherein said floor area has a frustum extending upwardly therefrom.

11. The vent stop according to claim 10 wherein said frustum has one or more frustum side surfaces extending upwardly of said floor surface.

12. The vent stop according to claim 11 wherein said frustum has a generally horizontal top surface extending from an end of said frustum side surfaces opposite said floor area.

13. The vent stop according to claim 12 wherein said second end portion of said spring travels from a first position on first side of said frustum to a second position on a second side of said frustum as said frustum moves from a first position to a second position.

14. The vent stop according to claim 13 wherein said second end portion of said spring travels from a first position in said recess formed by the first sidewall, said first end wall portion and said first sidewall of said center end wall portion to a second position in said recess formed by the second sidewall, said second end wall portion and said second sidewall of said center end wall portion.

15. The vent stop according to claim 14 wherein when said second end portion spring is in said first position said tumbler is in a fully extended position.

16. The vent stop according to claim 15 wherein when said second end portion of said spring is in said second position, said tumbler is in a partially extended position.

17. The vent stop according to claim 16 wherein when said second end portion of said spring is in said third position, said tumbler is in a retracted position.

18. The vent stop according to claim 12 wherein when said tumbler moves from a fully extended position to a partially extended position to a retracted position said second end portion of said spring moves from a first position on one side of said frustum to a second position in said recess formed by the second sidewall, said second end wall portion and said second sidewall portion of said center end wall portion and from said second position to a third position said spring moves to a side of said frustum opposite said first position and from said third position said spring moves to a side of said frustum fourth position in said recess formed by the first sidewall, said first end wall portion and said first sidewall of said center end wall portion.

19. The vent stop according to claim 5 wherein said tumbler has a bottom surface opposite of and end of said tumbler that extends from said housing, said bottom surface having a plate extending outwardly of said bottom surface, said plate having a first surface and a second surface and wherein one of said surfaces has a post extending therefrom for receiving a portion of said spring to hold said spring in position.

20. The vent stop according to claim 19 wherein said post is generally cylindrical.

21. The vent stop according to claim 20 wherein said tumbler has a top surface and a pair of side surfaces extending therefrom and wherein one surface of said plate is in generally the same plane as one of said side surfaces.

22. The vent stop according to claim 21 wherein the side of the plate that is generally in the same plane with said side surfaces of said tumbler is opposite the side of said plate that has said post extending therefrom.

23. The vent stop according to claim 22 wherein said bottom surface of said tumbler has a pin extending therefrom, to that contacts a surface of said spring.

24. The vent stop according to claim 23 wherein said pin retains said spring on said post extending from said plate.

25. The vent stop according to claim 1 wherein said spring comprises a pivot member, a loop portion, a free arm, and a shaped end; said first end of said spring being an end of said pivot member, said second end of said spring being said shaped end.

26. The vent stop according to claim 25 wherein said pivot member of said spring comprises a first portion and a second portion; said second portion extending at angle from said first portion.

27. The vent stop according to claim 26 wherein said loop portion of said spring extends from said second portion of said pivot member and has a body having at least one loop with a radius adapted to be received by a pivot member

28. The vent stop according to claim 27 wherein said free arm of said spring extends from said loop portion and comprises a first portion and a second portion; said second portion extending at an angle from said first portion.

29. The vent stop according to claim 28 wherein said shaped end of said spring extends from said second portion of said free arm of said spring.

30. The vent stop according to claim 29 wherein said shaped member of said spring is in the shape of a “U”.

31. The vent stop according to claim 29 wherein said shaped member of said spring is in the shape of a “V”.

32. The next stop according to claim 29 wherein said shaped member of said spring is in the shape of an “L”.

33. The vent stop according to claim 29 wherein said shaped end of said spring further comprises a curved portion, a first member, a bottom loop, and a free end.

34. The vent stop according to claim 33 wherein said curved portion of said spring curves down towards the bottom surface of said vent stop from said second portion of said free arm.

35. The vent stop according to claim 33 wherein said first member of said shaped end portion of said spring extends down from said curved portion towards the bottom surface of said vent stop.

36. The vent stop according to claim 33 wherein said bottom loop of said spring has a generally curved shape, and extends from said first member and curves upward.

37. The vent stop according to claim 33 wherein said free end of said spring extends up from said loop portion of said spring towards said vertical opening of said vent stop.

38. A vent stop for use with a first sash member and a second sash member, wherein said first sash member slides with respect to said second sash member, wherein the vent stop comprises: a housing adapted to be disposed in a recess in said second sash member, said housing formed by a face plate, a front wall, a rear wall, and first and second sidewalls, said front and rear walls and said sidewalls extend from said face plate to thereby define a housing cavity; a tumbler that is pivotally mounted in said housing cavity, said tumbler including an apex which protrudes from said housing cavity when said tumbler is rotated from a retracted position to an extended position; said tumbler being biased by a spring which biases the tumbler toward a partially extended position and the extended position, where said tumbler in a fully extended position is adapted to overlie an edge of said first sash member to prevent movement of said first sash member relative to said second sash member and in a partially extended position, said tumbler permitting said first sash member to slide over said tumbler and thereby causing said tumbler to be retracted further into said housing; thereby releasing said tumbler so that it can extend to a fully extended position when said first sash member is no longer over said second sash member.

39. The vent stop according to claim 38 wherein said housing having a base inside said cavity at an end of said sidewalls opposite said top surface, said base having an inner surface and an outer surface, said inner surface of said base having a recess area in said inner surface, said recess area providing a track for an end portion of said spring to travel as said tumbler is moving from a fully extended position to a partially extended position.

40. The vent stop according to claim 39 wherein said spring has a first end portion secured to said tumbler and a second end portion that travels in said recess portion.

41. A vent stop for use with a first sash member and a second sash member, wherein said first sash member slides with respect to said second sash member, wherein the vent stop comprises: a housing adapted to be disposed in a recess in said second sash member, said housing formed by a face plate, a front wall, a rear wall, and first and second sidewalls, said front and rear walls and said sidewalls extend from said face plate to thereby define a housing cavity; a tumbler that is pivotally mounted in said housing cavity, said tumbler including an apex which protrudes from said housing cavity when said tumbler is rotated from a retracted position to an extended position; said tumbler being biased by a spring which biases the tumbler toward a partially extended position and the extended position, and wherein when said tumbler is in a partially extended position said tumbler permitting said first sash member to slide over said tumbler when said first sash member moves from a first position to a second position, said movement thereby causing said tumbler to be retracted further into said housing, thereby releasing said tumbler, and wherein, when said first sash returns to said first position said tumbler being in a fully extended position whereby said first sash is being prevented by said tumbler from moving past said tumbler as said first sash is moved from said first position.

42. The vent stop according to claim 41 wherein said housing having a base inside said cavity at an end of said sidewalls opposite said top surface, said base having an inner surface and an outer surface, said inner surface of said base having a recess area in said inner surface, said recess area providing a track for an end portion of said spring to travel as said tumbler is moving from a fully extended position to a partially extended position.

43. The vent stop according to claim 42 wherein said recess has a first sidewall, a second sidewall and a first end wall, and a second end wall, one of said end walls extending from one sidewall to the opposite sidewall, the other of said end walls having a first end wall portion extending from one sidewall and a second end wall portion extending from the opposite sidewall, said first and second end wall portions being separated by a center end wall portion that extends into the recess area formed in said bottom wall.

44. A security lock for use in a sash window assembly having upper and lower sash window frames installed for vertical sliding movement, said upper sash frame having a recess into the interior thereof, said security lock comprising:
a casing adapted to be disposed in said recess, said casing including a cavity with a back wall therein;
a tumbler disposed in said cavity, said tumbler including a protruding apex at the top thereof;
pivot means for pivotally securing said tumbler to said casing for movement between an extended position where an edge of said tumbler overlies the top of the lower sash to prevent upward movement of the lower sash above the edge of said tumbler, a partially retracted position wherein said lower sash forces said tumbler further into said housing as said lower sash passes over said partially retracted tumbler a spring means for biasing said tumbler into said extended position.

45. A vent stop for use in a sliding member comprising a housing, a spring and a tumbler, said tumbler being rotatably mounted in said housing and having a fully extended position wherein a portion of said tumbler extends from said housing then when said tumbler is in its fully extended position and wherein said spring causes said tumbler to be released from said partially extended position to a fully extended position when said tumbler is moved to a more retracted position in said tumbler.
